(19) United States
(12) Patent Application Publication
(10) Pub. No.: US 2022/0314765 A1
(43) Pub. Date: Oct. 6, 2022

(54) TRANSPARENT PROTECTIVE COATING

(71) Applicant: Transparent Protective Coating LLC, Kenner, LA (US)

(72) Inventor: Stephen Klein, Metairie, LA (US)

(21) Appl. No.: 17/832,860

(22) Filed: Jun. 6, 2022

Related U.S. Application Data
(63) Continuation of application No. 16/699,387, filed on Nov. 29, 2019.
(60) Provisional application No. 62/773,771, filed on Nov. 30, 2018.
(60) Provisional application No. 62/809,853, filed on Feb. 25, 2019.

(51) Int. Cl. B60J 11/08

(52) U.S. Cl. CPC B60J 11/08

(57) ABSTRACT

A disclosed system provides protection to a window or windshield and includes a high-strength, high-toughness, transparent covering material, and attachment members. The covering material may be removably secured over the window or windshield via the attachment members. The covering material includes a handle, attached to covering material, which is configured to transmit an applied force from the handle to the covering material. The covering material is configured to bend or break in response to a force applied to the handle. A barrier material having a raised profile extending from a surface of the covering material is also provided. The barrier material is configured to divert liquid, incident on the covering material, to edges of the covering material. An embodiment covering material includes a polycarbonate material having a thickness of between 1 mm and 6 mm. The covering material includes coating materials that provide scratch resistance and protection from ultra-violet radiation.

### CROSS-REFERENCE TO RELATED APPLICATIONS

This application claims benefit of U.S. Provisional Application No. 62/773,771, filed on Nov. 30, 2018, and also claims benefit of U.S. Provisional Application No. 62/809,853, filed on Feb. 25, 2019, the entire contents of each of which are incorporated herein by reference.

### BRIEF DESCRIPTION OF THE DRAWINGS

The accompanying drawings are part of the disclosure and are incorporated into the present specification. The drawings illustrate example embodiments of the disclosure and, in conjunction with the description and claims, serve to explain, at least in part, various principles, features, or aspects of the disclosure. Certain embodiments of the disclosure are described more fully below with reference to the accompanying drawings. However, various aspects of the disclosure may be implemented in many different forms and should not be construed as being limited to the implementations set forth herein. Like numbers refer to like, but not necessarily the same or identical, elements throughout.

FIG. 1 shows a rear window of a commercial truck.

FIG. 2 shows rear and side windows of a pickup truck.

FIG. 3 shows a protective system for a vehicle windshield or window, in accordance with one or more embodiments of the present disclosure.

FIG. 4 shows a protective system for a vehicle windshield or window in pre-installation configuration, in accordance with one or more embodiments of the present disclosure.

FIG. 5 shows side windows and windshield of a pickup truck.

FIG. 6 shows a vehicle with a broken windshield.

FIG. 7 shows a vehicle windshield being replaced.

FIG. 8 shows a protective system installed on a rear window of a commercial truck, in accordance with one or more embodiments of the present disclosure.

FIG. 9A shows a first view of a handle for a protective system, in accordance with one or more embodiments of the present disclosure.

FIG. 9B shows a second view of a handle for a protective system, in accordance with one or more embodiments of the present disclosure.

FIG. 10A shows a method of engaging a handle of a protective system, in accordance with one or more embodiments of the present disclosure.

FIG. 10B shows a method of engaging a handle of a protective system, in accordance with one or more embodiments of the present disclosure.

FIG. 11A shows a handle for a protective system in an installed configuration, in accordance with one or more embodiments of the present disclosure.

FIG. 11B shows a protective system in an installed configuration, in accordance with one or more embodiments of the present disclosure.

FIG. 11C shows a protective system in an uninstalled configuration, in accordance with one or more embodiments of the present disclosure.

FIG. 12A shows a barrier material installed on a protective system, in accordance with one or more embodiments of the present disclosure.

FIG. 12B shows a barrier material installed on a protective system, in accordance with one or more embodiments of the present disclosure.

FIG. 12C shows a path of liquid diverted by a barrier material installed on a protective system, in accordance with one or more embodiments of the present disclosure.

FIG. 12D shows a sealant being applied to close a gap between a protective system and a rear window of a commercial truck, in accordance with one or more embodiments of the present disclosure.

FIG. 13A shows a flexible material that may be used as a barrier material, in accordance with one or more embodiments of the present disclosure.

FIG. 13B shows a flexible material that may be used as a barrier material, in accordance with one or more embodiments of the present disclosure.

FIG. 14 is a flowchart illustrating a method of protecting a windshield or window, in accordance with one or more embodiments of the present disclosure.

### DETAILED DESCRIPTION

This disclosure generally relates to systems and methods that provide improved protection for vehicle windows/windshields and other fragile objects requiring protection. Under various driving circumstances, vehicle drivers may encounter debris that may become airborne and may thereby hit vehicle windows/windshields. Such debris may come from roadway surfaces, from other vehicles, from the back of trucks, etc. Collisions of such airborne debris may cause damage to vehicle windows/windshields. Such damage may include chips, nicks, and cracks. In severe cases, windows/windshields may be completely shattered from airborne debris of sufficient size. As such, while slight damage may be a nuisance, severe damage may threaten bodily injury or death to vehicle occupants. Repair or replacement of vehicle windows/windshields may be costly and time-consuming, leading to inconvenience and potential economic loss.

Vehicle windows/windshields are designed to break upon impact in predetermined ways. Tempered glass, for example, breaks into tiny cubes under sufficient impact. The resulting small glass cubes are less hazardous than large glass fragments that may result from breaking conventional glass. Laminated glass is fabricated by forming a plastic or polymer layer (e.g., polyvinyl butyral (PVB)) sandwiched between two sheets of glass. The PVB layer provides structural stability to the glass when broken so that pieces of the broken glass are less likely to enter a vehicle passenger compartment. The presence of the PVB layer also tends to reduce the tendency of flying objects to penetrate the vehicle.

The way in which vehicle glass breaks also provides a safety feature. In this regard, such glass may be intentionally broken in an emergency situation by first responders, if needed, to rescue occupants from a vehicle. As such, there is a trade-off between the beneficial aspects of vehicle glass that is designed to break as a safety feature, and the undesirable tendency of such glass to suffer frequent damage from common road debris. Disclosed embodiments provide a solution to the above described problems by providing a system and method for enhanced protection of vehicle windows/windshields.

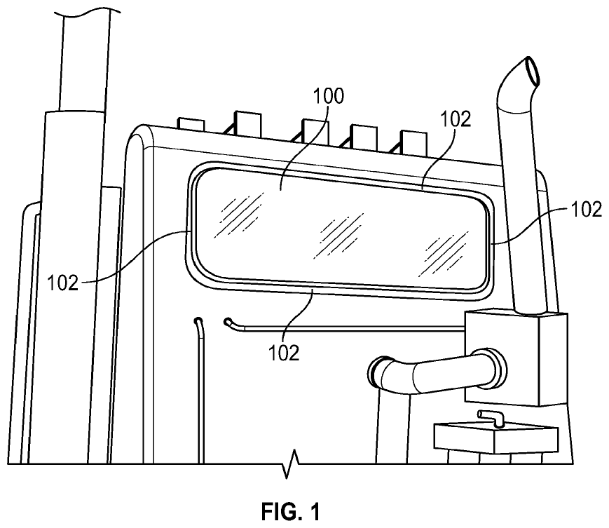

FIG. 1 shows a rear window 100 of a commercial truck. In this example, window 100 is a rear window for a tractor-trailer cab. When a tractor-trailer operator delivers a load of goods to a shipping destination, the trailer is often removed from the cab and left at the shipping destination. Upon removing the trailer from the cab, the operator may drive the cab back to a shipping place of origin to pick up another trailer to transport. When operating the cab without an attached trailer, windows of the cab, such as window 100, may be more susceptible to damage from airborne debris than when the trailer is connected to the cab. As such, rocks and other debris may be thrown by the cab's tires and may be directed to a window such as window 100. Impacts of such thrown debris may cause damage to window 100 causing the formation of chips, nicks, and cracks. In some instances, window 100 may become completely shattered due to impacts of thrown debris.

In this regard, rear window 100 may be configured as a substantially flat window having a substantially vertical orientation. Such a substantially flat, substantially vertical configuration may be more susceptible to debris that may hit rear window 100 at an angle that is nearly perpendicular to a surface of rear window 100. In contrast, curved windshields and side windows of trucks and automobiles may be less susceptible to damage than a substantially flat, substantially vertical window such as rear window 100.

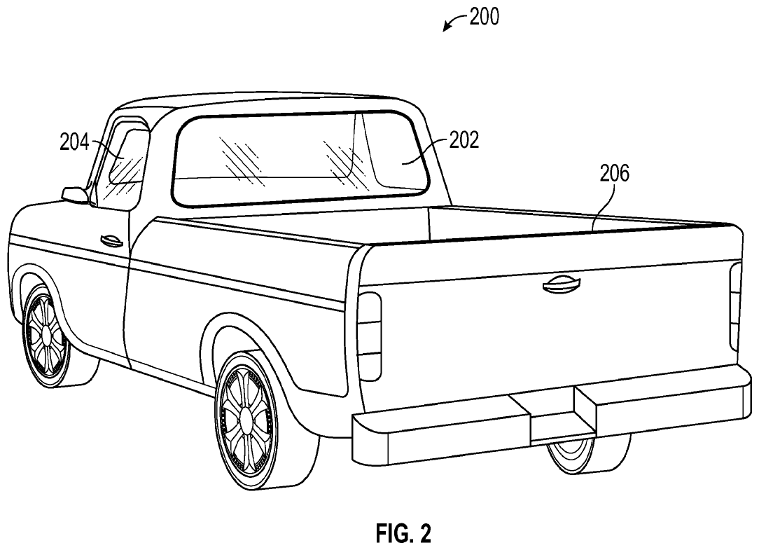

FIG. 2 shows rear 202 and side 204 windows of a pickup truck 200. Rear window 202 of pickup truck 200 is similar to rear window 100 of the commercial truck, described above with reference to FIG. 1. Rear window 202 may similarly be prone to damage from airborne debris that may include debris thrown from road surfaces, from other vehicles, or may include unsecured objected from a truck bed 206 of pickup truck 200. Airborne debris may also cause damage to side windows 204 of pickup truck 200.

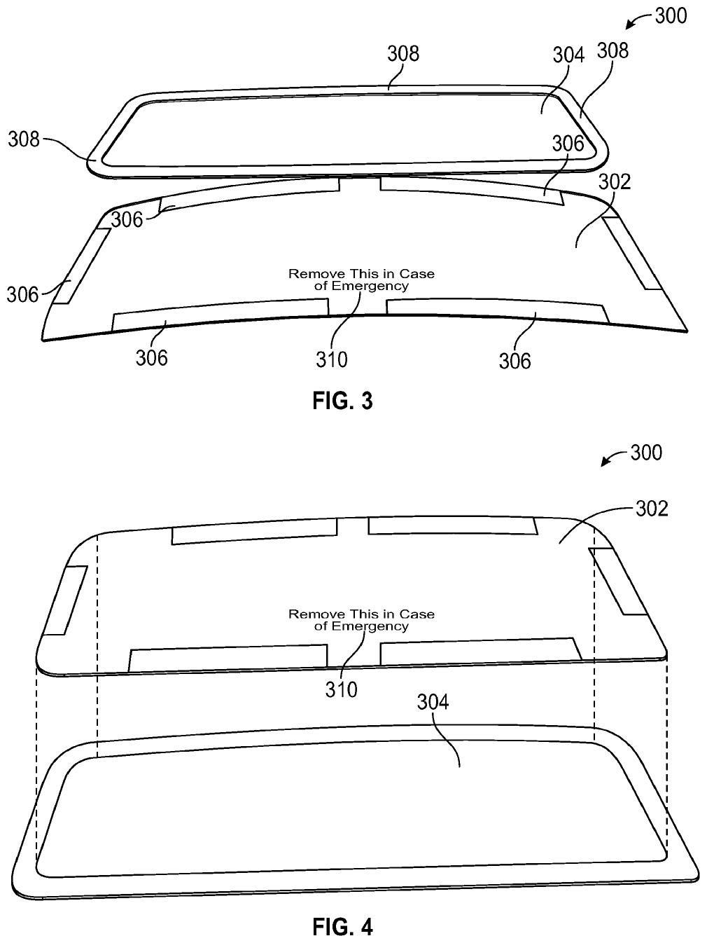

FIG. 3 shows a protective system 300 for a vehicle windshield or window 304, in accordance with one or more embodiments of the present disclosure. As described below, protective system 300 may be used to protect a vehicle window such as window 100, described above with reference to FIG. 1, or window 202, described above with reference to FIG. 2. In further embodiments, protective system 300 may be used to protect other vehicle windows or windshields, as described in greater detail below.

System 300 includes a clear protective covering 302 that is designed to be removably attached to windshield/window 304. According to an embodiment, covering 302 may be constructed of a clear material that has a higher damage resistance than that of conventional vehicle window/windshield glass. For example, covering 302 may be constructed from a sheet of polycarbonate, which is a high-strength, high-toughness, thermoplastic polymer material. In an embodiment, protective covering 302 may include a polycarbonate material that is approximately 200 times as strong as automotive glass and less than half the weight of automotive glass. Covering 302 may resist breakage and the formation of chips, nicks, and cracks, under impact from debris encountered during vehicle operation.

Covering 302 may be provided in a variety of transparent, high-strength, high-toughness materials of varying thicknesses. For example, covering 302 may have a thickness of 1 mm, 1.5 mm, 2 mm, 2.5 mm, 3 mm, 3.5 mm, etc., up to 18 mm. Covering 302 may have a thickness of from 1 mm to 18 mm, or from 0.03 inches to 0.72 inches, etc., in various increments. In an embodiment, covering 302 may have a thickness of approximately ⅛ inch.

Covering 302 may be configured to be removable in case of an emergency. In this regard, covering 302 may be provided with attachment members 306 along edges of covering 302. For example, attachment members 306 may include Velcro fasteners. Similarly, edges of a vehicle windshield/window 304 may include corresponding attachment members 308. For example, attachment members 308 may be complementary Velcro fasteners. As such, covering 302 may be removably attached to windshield/window by attaching complementary Velcro fasteners 306 of covering 302 and Velcro fasteners 308 of windshield/window 304. Other embodiments may include any other type of removable fasteners as needed for any given application. Attachment members 306 may be secured to covering 302 using glue or another adhesive. Similarly, complementary attachment members 308 may be secured to window 304 using glue or another adhesive. In this example, the complementary attachment members 308 reside on an external surface of the vehicle windshield/window 304. In this regard, the external surface faces an exterior region of the motor vehicle, and the external surface is opposite to an internal surface that faces an interior region of the motor vehicle,

FIG. 4 shows protective system 300 for a vehicle windshield/window in a pre-installation configuration, in accordance with one or more embodiments of the present disclosure. In this view, covering 302 is aligned and ready to be removably attached to window 304. In this configuration, covering 302 provides damage protection to window 304. In an emergency, covering 302 may easily be removed as needed. For example, if first responders require window 304 to be broken to allow occupants to be rescued, removal of covering 302 allows window 304 to be broken as needed. As shown in FIGS. 3 and 4, covering 302 may include a warning message 310 instructing covering 302 to be removed in an emergency.

Covering 302, described above with reference to FIGS. 3 and 4, may be suitable for protecting a window of a commercial truck, such as window 100 shown in FIG. 1, or window 202 of FIG. 2. For example, edges 102 of window 100 (e.g., see FIG. 1) may include attachment members, as described above with reference to FIGS. 3 and 4. Attachment members provided on edges 102 of window 100 may form a removable attachment with corresponding attachment members 306 of a protective covering such as covering 302. For example, attachment members provided on edges 102 of window 100 may be Velcro fasteners. Such Velcro fasteners on edges 102 of window 100 may be configured to attach to complementary fasteners 306 of covering 302. As with the embodiments of FIGS. 3 and 4, protective covering 302 may be removed from window 100 in case of an emergency. Other embodiments may include any other type of removable fasteners as needed for any given application.

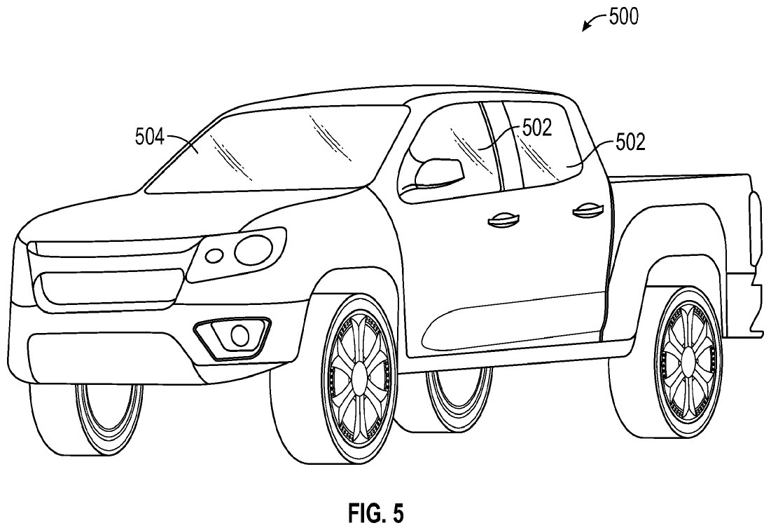

FIG. 5 shows side windows 502 and windshield 504 of a pickup truck 500. Further embodiments may provide a protective system (similar to system 300 of FIGS. 3 and 4) that may be configured to protect side windows and a windshield of a vehicle (such as side windows 502 and windshield 504 of pickup truck 500 shown in FIG. 5). Further embodiments may be configured to protect windows and/or windshields of other types of vehicles, such as cars, trucks, buses, etc.

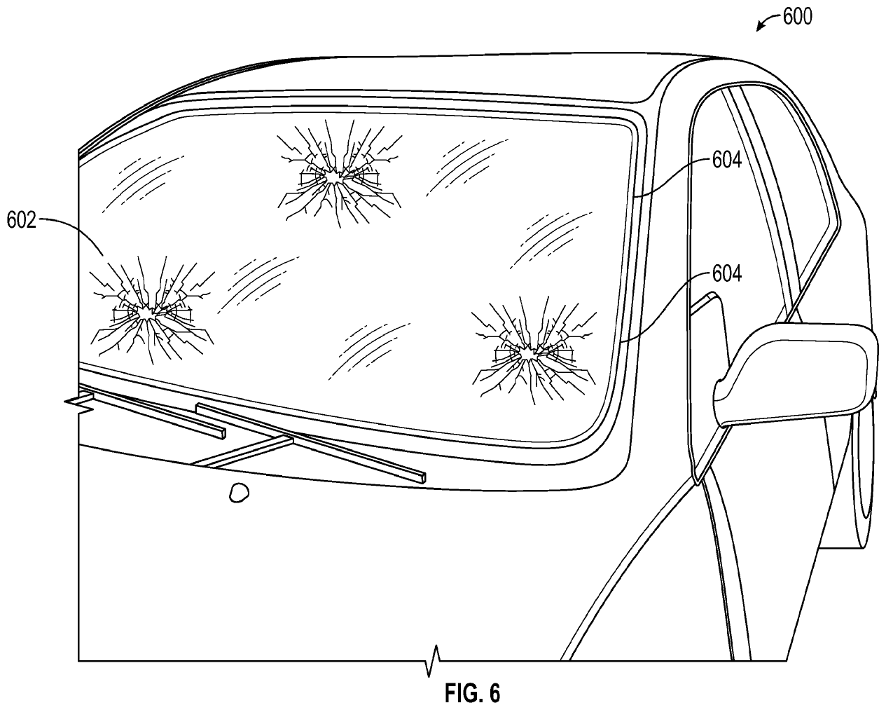

FIG. 6 shows a vehicle 600 with a broken windshield 602. With minor damage that only includes nicks, chips, or small cracks, it may be possible to repair a damaged windshield. Windshield 602, however, exhibits extensive damage that cannot be repaired. In this example, replacement is the only option. Windshield 602 is attached to a windshield housing along a peripheral edge 604. A broken windshield may be replaced by removing it from the housing by detaching the windshield along edge 604.

FIG. 7 shows a vehicle windshield 700 being replaced. Replacement involves detachment and removal of the broken windshield and installation of a new windshield. As mentioned above, replacement of a vehicle windshield can be costly and time consuming. Costs may include material cost for the replacement windshield, disposal cost of the broken windshield, labor costs, etc. Down time, while a windshield is being replaced, may also lead to economic losses. Commercial vehicles, for example, may be prevented from operating when damage from road debris is extensive. Once a vehicle has been sidelined by windshield damage, delays may occur due to lack of availability of parts and service personnel needed to perform the work of replacement. Such damage may thus lead to schedule delays, cost overruns, lost wages, etc. Disclosed embodiments, such as system 300 described above with reference to FIGS. 3 and 4, may provide protection for automobile windshields, such as windshield 602 shown in FIG. 6, and described above.

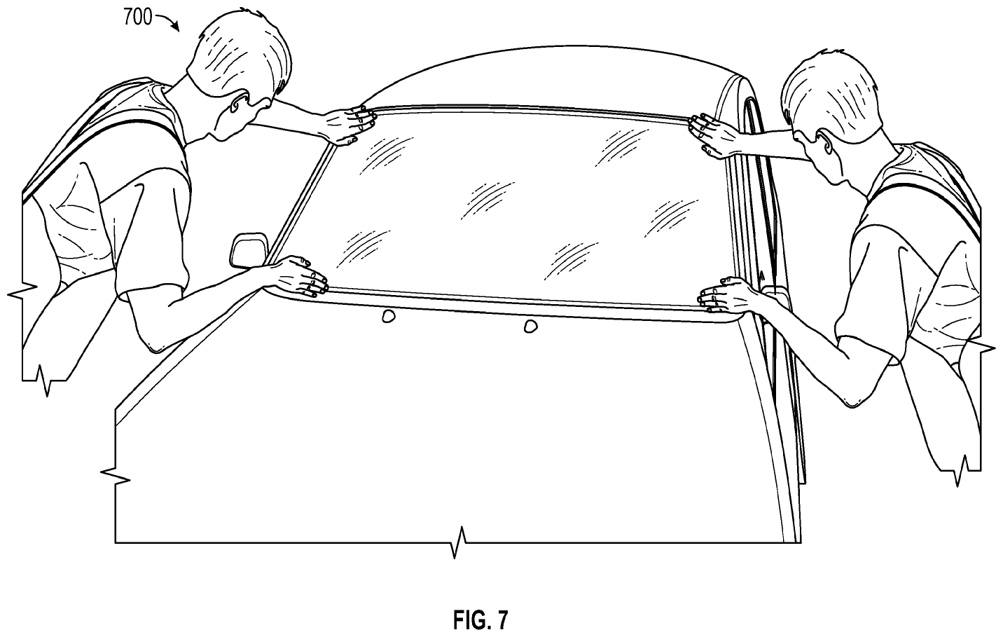

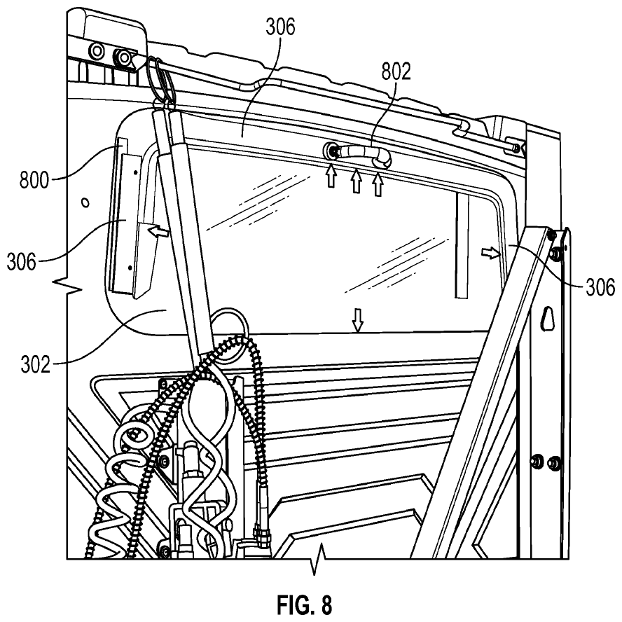

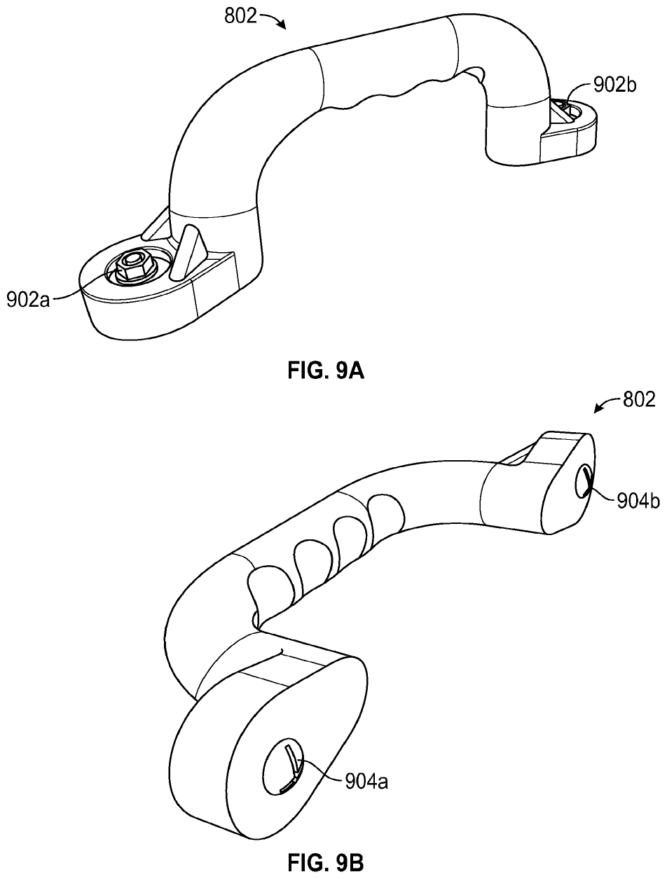

FIG. 8 shows a protective covering 302 installed on a rear window 800 of a commercial truck, in accordance with one or more embodiments of the present disclosure. In this example, rear window 800 may be a substantially flat, substantially vertical window. Protective covering 302 may be a substantially flat, high-strength, high-toughness, transparent covering material configured to be removably secured over the substantially vertical window. As described above, protective covering 302 is secured by attachment members 306 that engage with corresponding attachment members of rear window 800. In this example, protective covering 302 further includes a grasping member taking the form of a handle 802 that may be used to remove protective covering 302 in an emergency or for routine cleaning, etc. Further details of handle 802 are described below with reference to FIGS. 9A to 11C.

In further embodiments, protective covering 302 may have different types of grasping members (not shown) that extend in a direction away from a surface of protective covering 302. Such grasping members may take many forms and may be configured to transmit an applied force from the grasping member to the covering material (e.g., protective covering 302). Such grasping members may be configured to be attached to protective covering 302 using fasteners, as described in greater detail below. In further embodiments, a grasping member may be molded to the covering material.

FIGS. 9A and 9B show two views of handle 802. Handle 802 may be a single injection molded structure. FIG. 9A shows a top view of handle 802 illustrating fasteners 902a and 902b. Fasteners 902a and 902b may be nuts that may be configured to engage with corresponding screws 904a and 904b, as shown in the side view of handle 802 shown in FIG. 9B. Handle 802 may be configured to have dimensions that accommodate a typical human hand. For example, handle 802 may have dimensions such that a distance between fasteners 902a and 902b is approximately five inches. Handle 802 may be installed on protective covering 302 (e.g., see FIG. 8) by placing screws 902a and 902b through holes (not shown) in protective covering 302, by threading screws 904a and 904b through holes in handle 802, and by engaging screws 904a and 904b with corresponding nuts 902a and 902b to thereby secure handle 802 to protective covering 302. Handle 802, so installed, is shown in FIGS. 8 and 10A to 11C.

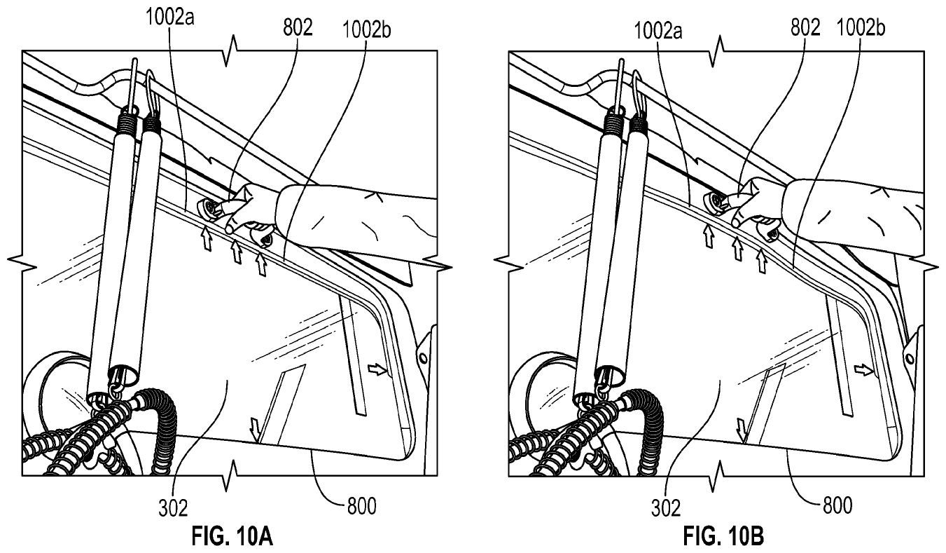

FIGS. 10A and 10B show a method of engaging a handle of a protective system, in accordance with one or more embodiments of the present disclosure. In FIG. 10A, a person grasps handle 802 and in FIG. 10B the person applies a force to handle 802 to pull protective covering 302 away from window 800. Applying a force to handle 802 in this way allows removal of protective covering 302 from window. Protective covering 302 may be removed in this way in the absence of mechanical obstructions. In an emergency situation, there may be one or more obstructions preventing easy removal of protective covering 302. In such an instance, applying a force to handle 802 may cause protective covering 302 to deform so that it may bend sufficiently to clear the obstruction. Alternatively, protective covering 302 may be configured to break when sufficient force is applied to handle 802. For example, applying a force to handle 802 causes a stress concentration, for example, in regions 1002a and 1002b near installation holes (not shown) in protective covering 302. Stress concentration in regions 1002a and 1002b, for example, may facilitate breakage of protective covering 302.

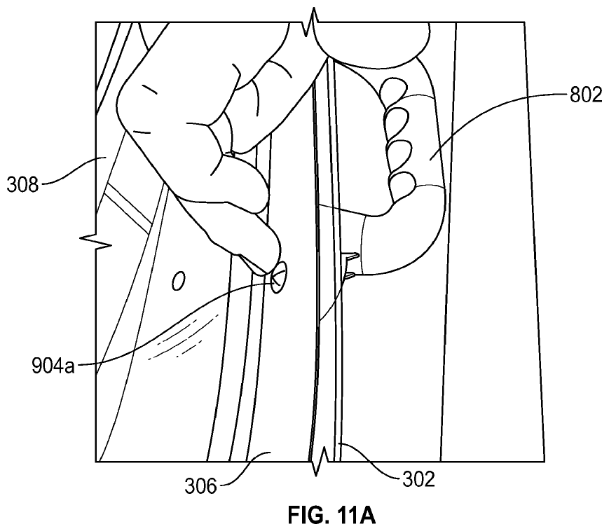

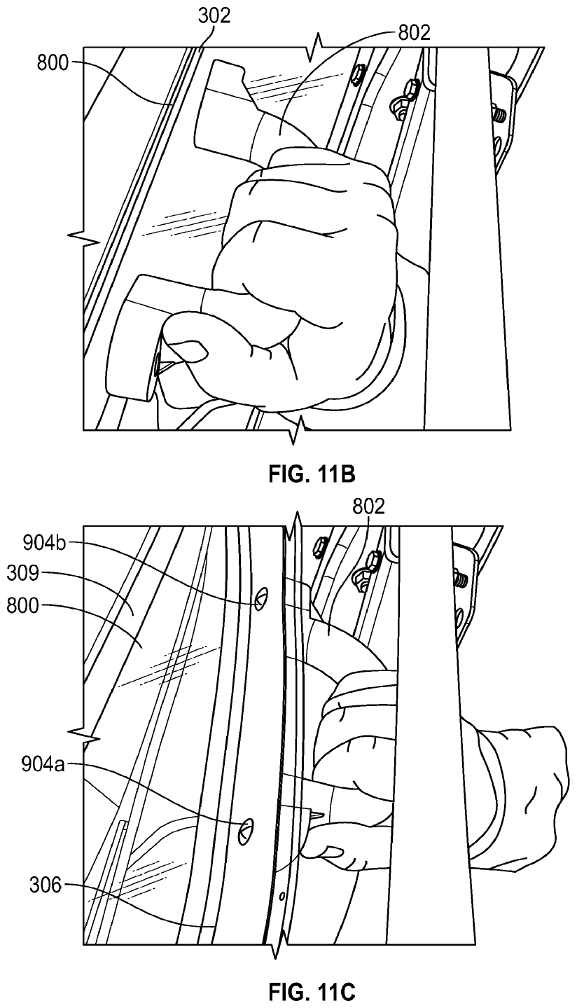

FIG. 11A shows handle 802 for a protective covering 302 in an installed configuration, in accordance with one or more embodiments of the present disclosure. In this configuration, fastener 904a has been installed in protective covering 302 as described above. In this regard, fastener 904a is a screw that is threaded through a hole (not shown) in protective covering 302. Fastener 904a further is threaded through a corresponding hole (not shown) in handle 802. Fastener 902a (e.g., see FIG. 9A) is engaged with fastener 904a (e.g., see FIG. 9B) to generate a secure attachment of handle 802 to protective covering 302. As mentioned above, fastener 902a may be a nut that may be configured to engage with fastener 904a (i.e., a screw).

In this example (e.g., see FIG. 11A), fastener 904a is positioned to reside within a region occupied by attachment member 306. In this configuration, a protruding end of fastener 904a is spatially aligned with complementary attachment member 308 on the window or windshield. Similarly, a protruding end of fastener 904b (e.g., see FIG. 11C) may be configured to be spatially aligned with complementary attachment members 308. As such, when protective covering 302 is installed on the window or windshield, complementary attachment members 308 on the window or windshield may prevent direct contact between the protruding ends of the fasteners (e.g., protruding ends of fasteners 904a and 904b) and the window or windshield. In this way, complementary attachment members 308 provide protection to the window or windshield from damage due to direct contact with the protruding ends of the fasteners 904a and 904b.

FIG. 11B shows protective covering 302 in an installed configuration, in accordance with one or more embodiments of the present disclosure. In this example, handle 802 has been used to push protective covering 302 against window 800. In this configuration, attachment members 306 engage with complementary attachment members 308 (e.g., see FIGS. 3, 11A and 11C) to removably secure protective covering 302 to window 800. As such, attachment members 306 and complementary attachment members 308 are configured to hold protective covering 302 against window 800 with an attachment force. Removal of protective covering 302 from window 800, therefore, requires application of a force sufficient to overcome the attachment force.

FIG. 11C shows a protective system in an uninstalled configuration, in accordance with one or more embodiments of the present disclosure. In this example, a person has grasped handle 802 and has applied a force sufficient to overcome the above-described attachment force generated by attachment members 306 and complementary attachment members 308. As shown in this view, protruding ends of fasteners 904a and 904b are spatially aligned with complementary attachment member 308. In this way, complementary attachment member 308 provides protection for window 800 by preventing direct contact between protruding ends of fasteners 904a and 904b and window 800. Thus, in an installed configuration (e.g., see FIG. 11B) protruding ends of fasteners 904a and 904b make contact with complementary attachment member 308, rather than making direct contact with window 800.

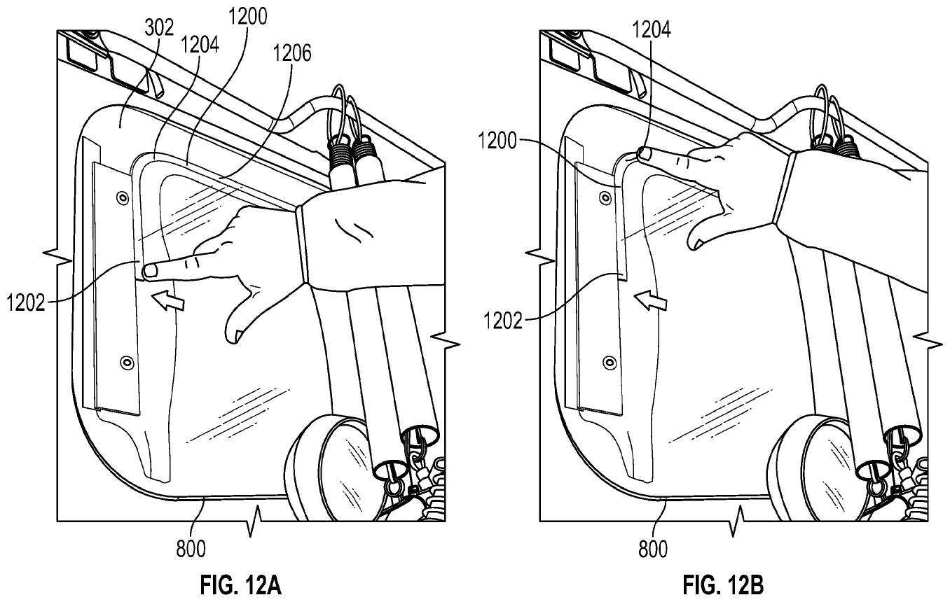

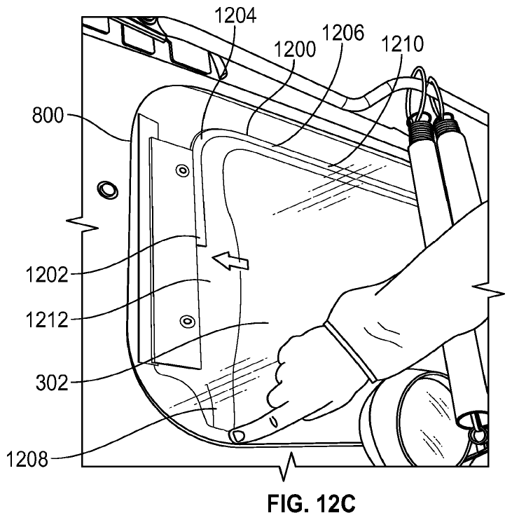

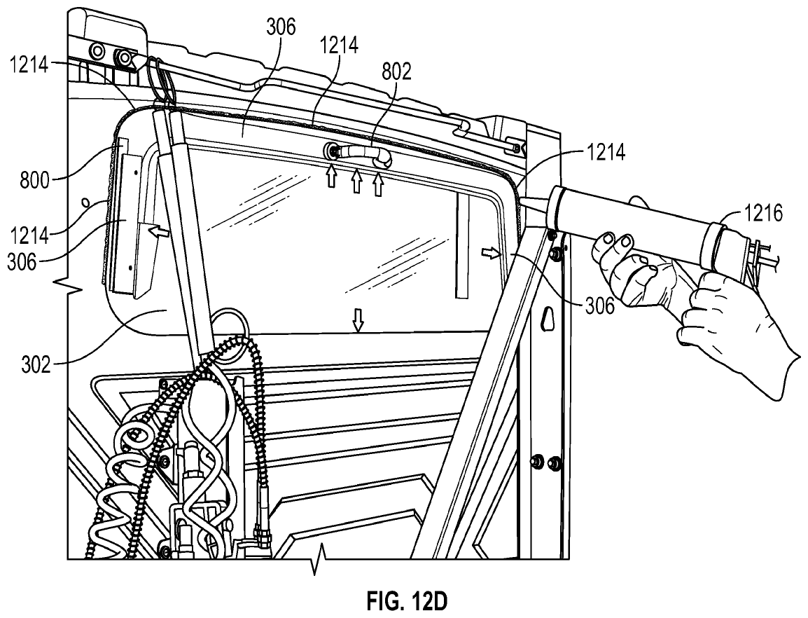

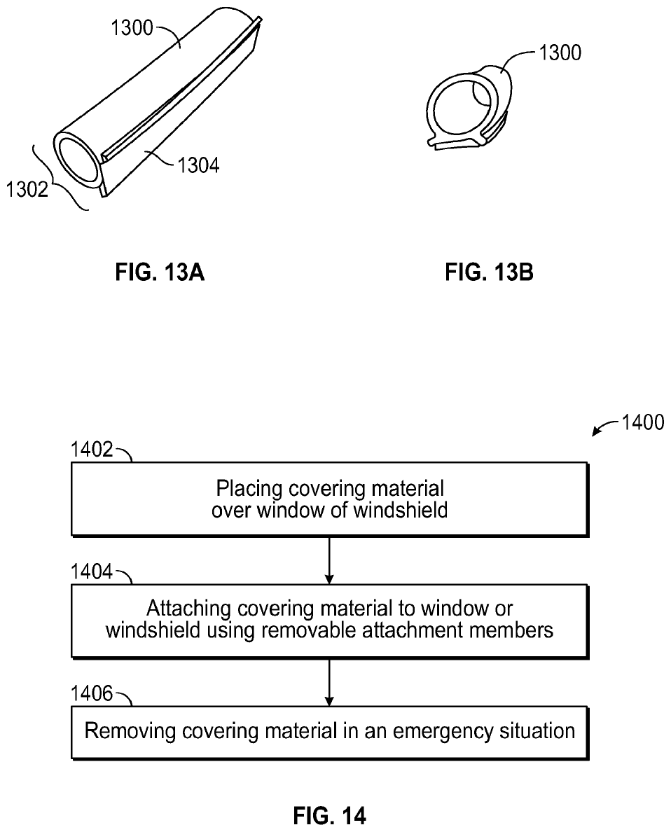

FIGS. 12A and 12B show a barrier material 1200 provided on protective covering 302, in accordance with one or more embodiments of the present disclosure. Barrier material 1200 may be configured to divert a liquid incident on protective covering 302, to edges of protective covering 302. For example, barrier material 1200 may be provided as a thin strip of material having a raised profile extending from a surface of protective covering 302. In this view, barrier 1200 extends from an inner surface of protective covering 302 toward window 800. As described in greater detail with reference to FIGS. 13A and 13B, below, barrier material 1200 may be a thin flexible material (e.g., a rubber material) that makes direct contact between a surface of protective covering 302 and a surface of window 800. Further, barrier material may have a shape that is configured to divert liquid to edges of protective covering 302.

In the example of FIGS. 12A and 12B, barrier material 1200 may have in inverted “U” shape. As illustrated, barrier material 1200 may have a first end 1202, a first curved portion 1204, and a straight portion 1206. Barrier material 1200 may be symmetrically shaped to have similar features on an opposite side including a second end and a second curved portion (not shown in this view). The presence of barrier 1200 deflects incident liquids, such as rain water, to edges of protective covering 302. In this way, during rainy driving conditions, barrier material 1200 improves visibility of objects viewed through window 800 (e.g., objects viewed via a rear-view mirror), relative to embodiments that omit barrier material 1200.

FIG. 12C shows a path 1208 of liquid diverted by barrier material 1200 installed on protective covering 302, in accordance with one or more embodiments of the present disclosure. Under various conditions, incident liquid (e.g., rain water) may encounter barrier material 1200 from various angles. For example, water may enter a gap between window 800 and protective covering 302 near a top region 1210 of protective covering 302. Water may then travel between window 800 and protective covering 302 and may then encounter barrier material 1200 along an edge of barrier material 1200. For example, water may encounter barrier material 1200 along straight portion 1206 or along curved portion 1204 of barrier material 1200. Because barrier material 1200 makes contact and touches both window 800 and protective covering 302, water encountering barrier material 1200 may be diverted to flow along barrier material 1200 and to thereby be diverted to edges of protective covering 302. In this example, water flows along edges of barrier material 1200 and thereby flows down the left edge of window 800 along path 1208, as shown in FIG. 12C.

A presence of water between window 800 and protective covering 302 causes condensation 1212, as shown in FIG. 12C, which may obscure visibility of objects viewed through window 800 and protective covering 302. As shown in this example, such condensation 1212 may be confined to an edge region of window 800, because the presence of barrier material 1200 diverts a flow of liquid toward edge regions of window 800. As described above, confining water flow and corresponding condensation 1212 to edge regions of window 800 improves visibility by increasing a spatial extent of clear regions of window 800 and protective covering.

FIG. 12D shows a sealant being applied to close a gap between window 800 and protective covering 302, in accordance with one or more embodiments of the present disclosure. After protective covering 302 has been installed on window 800, as described above, a sealant may be applied to reduce a tendency for moisture to gather between window 800 and protective covering 302. In this regard, a sealant may be applied to form a bead 1214 to prevent moisture from entering a gap between window 800 and protective covering 302. In this example, sealant is applied using a device 1216 such as a caulking gun. Sealant may be any suitable waterproof sealant such as waterproof caulk.

In this example, sealant has been applied in the form of a bead 1214 that extends along a top edge of window 800 and along side edges of window 800, as shown in FIG. 12D. In this example, a gap between window 800 and protective covering 302 is left open along a bottom edge of window 800. Such an open gap may be advantageous in preventing condensation between window 800 and protective covering 302. In further embodiments, sealant may be applied around the entire edge of window 800 to completely seal the gap between window 800 and protective covering 302. In certain embodiments, sealant may be an adhesive or may be a non-adhesive sealant. Use of a non-adhesive sealant may be advantageous in situations in which protective covering 302 needs to be removed, for example, in an emergency.

FIGS. 13A and 13B show views of a section of flexible material 1300 that may be used as a barrier material, in accordance with one or more embodiments of the present disclosure. As shown in FIG. 13A, material 1300 may be a rubber material that may be provided as a cylindrical structure that may be a fraction of an inch in diameter 1302. For example, material 1300 may have a ¼ inch diameter, a ⅛ inch diameter, etc. The diameter of material 1300 may be chosen as needed for a given application. FIG. 13B illustrates an embodiment in which material 1300 is a rubber material having a hollow cylindrical structure. Various other configurations may be employed in other embodiments. For example, material 1300 may be provided having various other cross-section geometries including rectangular, square, triangular, etc. Further, material 1300 may be a hollow structure, as shown in FIG. 13B, or may have a solid structure (not shown).

In further embodiments, protective covering 302 may be provided with one or more coatings. For example, protective covering 302 may be provided with a scratch-resistant coating. In other embodiments, protective covering 302 may be provided with a coating the protects from damage due to ultra-violet radiation.

The disclosed embodiments are not limited to transparent coverings for vehicle windows/windshields and may be used to provide protection to aircraft windscreens, windows on boats/ships, motorcycle windscreens, etc. Further embodiments may include similar removable covering materials for other types of fragile objects that require a transparent covering. For example, additional embodiments may provide protection to windows of a home from storm damage. Additional embodiments may be used as components of safety gear for soldiers, fire fighters, athletes, etc. Additional embodiments may provide protection to computer screens, mobile computing devices, wearable devices, eyewear, visors, etc. In further embodiments, attachment members may be placed on edges of the covering material or in any other location or locations on the covering material that may be suitable for a given situation.

FIG. 14 is a flowchart 1400 illustrating a method of providing protection to a windshield or window, in accordance with one or more embodiments of the present disclosure. In a first stage 1402, the method includes placing a covering material over a window or windshield. As described above, the covering material may be a transparent, high-strength, high-toughness material such as polycarbonate. The material may be chosen to have sufficient thickness to protect against damage from common roadway debris. For example, the covering material may have a range of thicknesses between approximately 1 mm and 6 mm. In another example, the covering material may have a thickness of approximately ⅛ inch.

In stage 1404, the method may include attaching the covering material to a window or windshield using attachment members that allow removable attachment. For example, the attachment members may be Velcro fasteners. In stage 1406, the method may include removing the covering in an emergency situation. For example, the covering may be removed by applying a force to a handle that is provided on the covering to thereby remove the covering. As described above, and illustrated in FIGS. 3 and 4, the covering material may include a warning message instructing the covering to be removed in an emergency situation. Such removal of the covering allows the window or windshield to be broken as needed.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

The specification and annexed drawings disclose examples of systems and methods that may provide improved protection for vehicle windows/windshields and other fragile objects. It is, of course, not possible to describe every conceivable combination of elements and/or methods for purposes of describing the various features of the disclosure, but those of ordinary skill in the art recognize that many further combinations and permutations of the disclosed features are possible. Accordingly, various modifications may be made to the disclosure without departing from the scope or spirit thereof. Further, other embodiments of the disclosure may be apparent from consideration of the specification and annexed drawings, and practice of disclosed embodiments as presented herein. Examples put forward in the specification and annexed drawings should be considered, in all respects, as illustrative and not limiting. Although specific terms are employed herein, they are used in a generic and descriptive sense only, and not used for purposes of limitation.

1-36. (canceled)

37. A method of protecting a substantially vertical rear automotive glass window of a cab of a tractor-trailer, the method comprising:
attaching window attachment members about window peripheral edges of the substantially vertical rear automotive glass window of the tractor-trailer, wherein an interior portion of the vertical rear automotive glass window within the window peripheral edges is free of visual obstruction;
securing a substantially flat transparent covering material over the vertical rear automotive glass window, wherein securing includes:
positioning the covering material such that a grasping member attached to the covering material is disposed proximate to one of the window peripheral edges, wherein the grasping member is configured to transmit an applied force from the grasping member to the covering material to selectively remove the covering material from the vertical rear automotive glass window;
engaging covering attachment members disposed proximate to one or more peripheral edges of the covering material with the window attachment members, wherein the covering attachment members are configured to removably engage the window attachment members, wherein the covering material substantially covers an outer surface of the vertical rear automotive glass window while the window attachment members, covering attachment members and grasping member are positioned proximate to the peripheral edges of the vertical rear automotive glass window to prevent visual obstruction through an interior of the vertical rear automotive glass window and the covering material.

38. The method of claim 37, further comprising:
utilizing the grasping member to remove the covering material in the event of an emergency.

39. The method of claim 38, wherein utilizing the grasping handle creates stress concentrations within the covering material in response to a force applied to the grasping handle.

40. The method of claim 37, wherein securing the covering material comprises:
positioning the grasping member in a direction away from a surface of the transparent covering material.

41. The method of claim 37, wherein the handle is attached to the covering material via fasteners extending through the covering material, wherein positioning the covering material comprises:
spacing the covering material from an outside surface the vertical rear automotive glass window such that the fasteners attaching the handle to the covering material remain free of contact with the vertical rear automotive glass window.

42. The method of claim 37, further comprising disposing a barrier material about a periphery of the covering material and the vertical rear automotive glass window wherein the barrier material is disposed between the covering material and the vertical rear automotive glass window.

43. The method of claim 37, further comprising diverting a liquid, that is incident on the covering material, to edges of the covering material by allowing the liquid to interact with a barrier material having a raised profile extending from a surface of the transparent covering material such that the barrier material resides in a space between the transparent covering material and the rear window while the device is attached over the rear window.

44. The method of claim 37, further comprising:
applying a sealant between the covering material and the vertical rear automotive glass window to seal a gap between the covering material and the vertical rear automotive glass window.

45. The method of claim 44, wherein the sealant is applied about top and side edges of the covering material and the vertical rear automotive glass window, wherein bottom edges of the covering material and the vertical rear automotive glass window remain free of sealant.

46. The method of claim 37, wherein engaging covering attachment members disposed proximate to one or more peripheral edges of the covering material with the window attachment members comprises engaging hook and loop fasteners.
